(19) United States
(12) Patent Application Publication
(10) Pub. No.: US 2023/0137123 A1
(43) Pub. Date: May 4, 2023

(54) WEIGHTED COVERING AND RELATED METHODS

(71) Applicant: Robyn R. Loveland, Valley, NE (US)

(72) Inventor: Robyn R. Loveland, Valley, NE (US)

(21) Appl. No.: 18/051,737

(22) Filed: Nov. 1, 2022

Related U.S. Application Data
(60) Provisional application No. 63/274,362, filed on Nov. 1, 2021.

(51) Int. Cl. A47G 11/00

(52) U.S. Cl. CPC A47G 11/003; A47G 2200/22

(57) ABSTRACT

This disclosure relates generally to indoor and outdoor covers, and in particular to weighted coverings and related methods. Disclosed herein is a covering comprising a first fabric layer having a first edge folded over on itself and forming a first void that can be filled with a fluid.

### CROSS REFERENCE TO RELATED APPLICATIONS

This application claims the benefit of U.S. Provisional Pat. Application No. 63/274,362, filed Nov. 1, 2021, and titled “WEIGHTED COVERING,” the contents of which are hereby incorporated herein by reference in their entirety.

### BACKGROUND OF THE INVENTION

The field of the invention relates generally to indoor and outdoor covers, and in particular to weighted coverings and related methods.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The embodiments disclosed herein will become more fully apparent from the following description and appended claims, taken in conjunction with the accompanying drawings. The drawings depict primarily particular embodiments, the features of which are applicable to the other embodiments disclosed herein.

FIG. 1 depicts one embodiment of a covering.

FIG. 2 illustrates a frontside of the covering depicted in FIG. 1.

FIG. 3 illustrates a close-up of one embodiment of a zipper formed in the covering depicted in FIG. 1 and operably connected to an orifice and configured to slidably seal off the orifice.

FIG. 4 depicts the front (left side) and back (right side) of the covering depicted in FIG. 1, with folding lines depicted on the back view.

FIG. 5 depicts one embodiment of a mechanism for securing the covering depicted in FIG. 1 in a stashbag. In the upper left is a depiction of the stashbag with the mechanism unsecured. In the upper right is a depiction of the stashbag with the mechanism unsecured. In the lower left is a depiction of the stashbag with the mechanism secured. In the lower right is a depiction of the stashbag with the mechanism secured.

FIG. 6 depicts another embodiment of a covering.

### DETAILED DESCRIPTION OF THE INVENTION

Weighted coverings can be useful in a variety of settings, such as when protecting tables, grills, furniture, napkin holders, food containers, cars, boats, recreational vehicles, and the like from the rain, sun, and dust. Weighted coverings that include permanent solid weights can be useful when in place on an item to be covered; however, covers with permanent solid weights can bulky and misshaped when folded-up for storage.

Weighted coverings with permanent fluid weights function the same as permanent solid weights and can be flexible during folding; however, they tend to still be bulky and misshaped when folded-up for storage. Coverings with the option to have fluid added to empty voids have the benefits of permanent solid and fluid weights, but with the added benefit of easier folding and less bulkiness when folded-up, when the fluid has been drained from the voids.

Coverings with fillable and drainable voids can include a bladder, lining the interior of the voids.

Alternatively, coverings with fillable and drainable voids can have the voids formed by folding a first fabric layer over on itself and forming a void that can be filled with a fluid. For example, the first fabric layer may have a first edge folded over on itself to define a first new edge and forming a first void that can be filled with a fluid.

The covering may be designed to be used indoors, outdoors, or both. For example, the covering may be shaped and configured to function as a tablecloth, a grill cover, a furniture cover, a napkin holder cover, a food container cover, a car cover, or a boat cover.

The covering may include a fluid in the void. The weight of the fluid may render the covering resistant to wind up to 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, and more mph.

The fluid will often be water; however, additives, such as to prevent mold growth, may be included in the fluid. Other fluids may also be used, with a preference for fluids that are safe for contact with children.

The covering may include 2, 3, 4, 5, 6, 7, 8, 9, 10, or more edges. For example, circular coverings may only have one edge, rectangular coverings four edges, and complex shapes may have numerous edges.

The covering may have a second void that can be filled with a fluid. The first void may be proximal the first new edge and the second void may be proximal a second new edge of the covering. Likewise, additional voids may be proximal additional new edges. For some coverings, not all of the edges have voids proximal their respective edges.

The coverings may include a second void proximal the first new edge and oriented in line with the first void when the cover is in use. For example, the first void may be broken into multiple voids along the first new edge. In another example, a second void may be formed adjacent the first void and parallel to it, running adjacent to the first void. In that example, the second void will be farther from the first new edge than the first void.

The first void may be 1, 2, 3, 4, 5, 6, 7, 8, 9, 10, 11, 12, 13 14, 15, or more inches from the first new edge. Likewise, additional voids may be placed as needed.

The covering may include a first orifice in fluidic communication with the first void. Fluid can be added or removed from the first void via the first orifice. A first cap may be operably connected to the first orifice and configured to removably seal off the first orifice. Alternatively, a first zipper may be operably connected to the first orifice and configured to slidably seal off the first orifice.

The covering may include a first fabric layer that comprises a woven or non-woven material comprised of natural or synthetic materials, such as a woven or non-woven flexible plastic layer. The first fabric layer may include rigid plastic components, metal components, wood components, or any combination thereof. The covering may be flexible through at least ½ of the surface area of the covering.

The voids will preferably be watertight. The first fabric layer may be welded to itself via RF welding to form the first void. For some coverings, it may be desirable to make the first fabric layer comfortable to the touch and to use a second fabric layer for forming water-tight voids. For such coverings, the second fabric layer may be bonded, sealed, or welded to itself via an adhesive or adhesive process or through a process such as RF welding to form the first void. Preferably, the first void forms a water-tight compartment, without the need for a separate bladder.

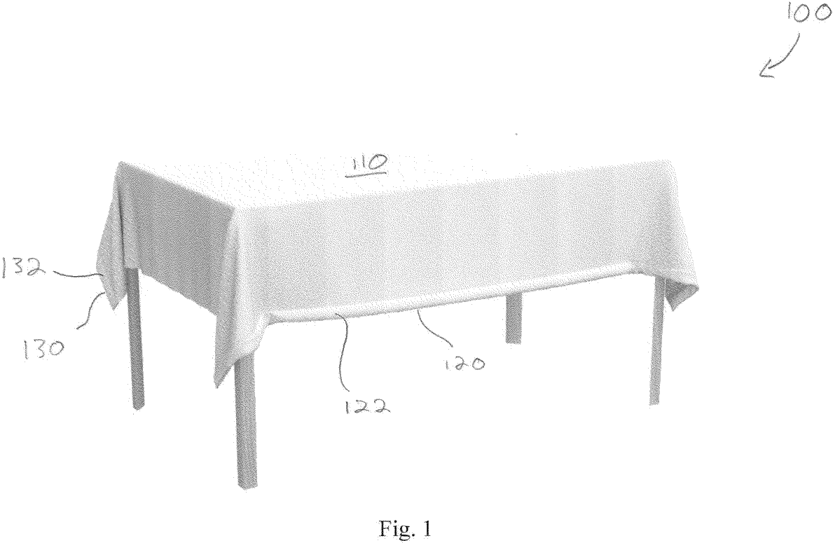

Reference will now be made to the Figures which disclose particular embodiments of the coverings disclosed herein. FIG. 1 depicts covering 100 configured to be used as a tablecloth or picnic blanket. Covering 100 includes a first fabric layer 110. The covering 100 has four edges and includes a first new edge 120 with a fluid filled first void 122 and a second new edge 130 with a fluid filled second void 132.

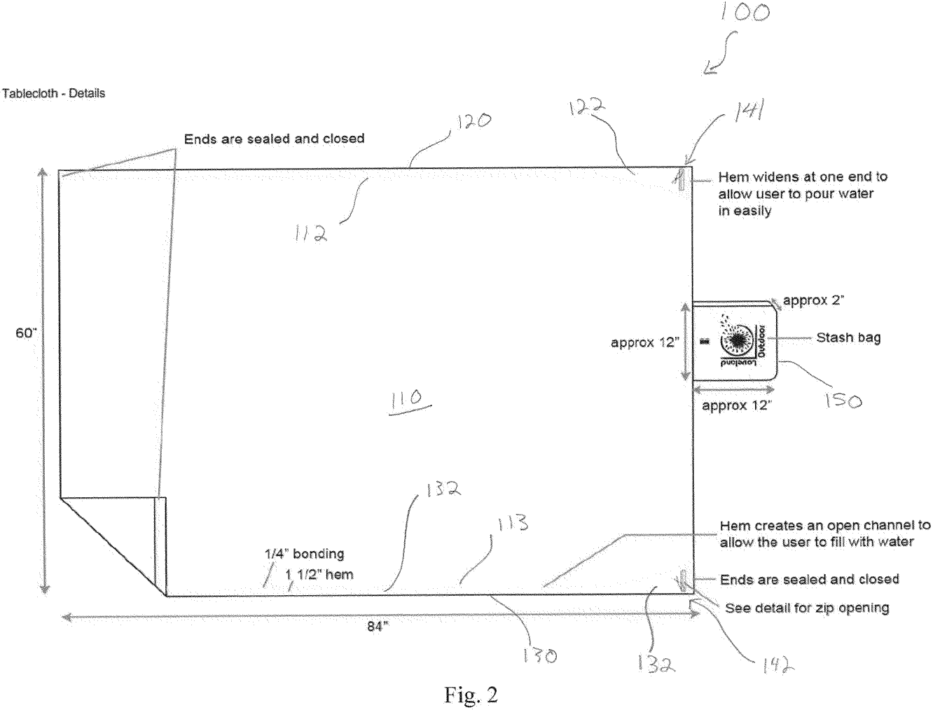

FIG. 2 illustrates a frontside of the covering 100. Fillable and drainable voids 122 and 132 are formed by folding, respectively, first edge 112 and second edge 113 each over on itself and then bonding the first fabric layer 110 to itself on the backside of the first fabric layer 110. Each of voids 122 and 132 is formed by bonding the first fabric layer 110, through a process such as via RF welding, along three edges of the respective void.

As depicted in FIG. 2, the covering 100 includes a first zipper 141 incorporated into the first fabric layer 110 within the compartment of the first void 122. The first zipper 141 is attached to the edges of an orifice (not shown) and is configured to slidably seal off the orifice. The first zipper 141 allows or bocks fluidic communication with the first void 122. Additionally, the covering 100 includes a second zipper 142 incorporated into the first fabric layer 110 within the compartment of the second void 132. The second zipper 142 provides the same functionality for the second void 132, as the first zipper 141 does for the first void 122.

The covering 100 further includes a stash bag 150, into which the remainder of the covering 100 may be folded and stored, when not in use. Water is preferably drained from the first and second voids 122 and 132 before folding the covering 100 into the stash bag 150.

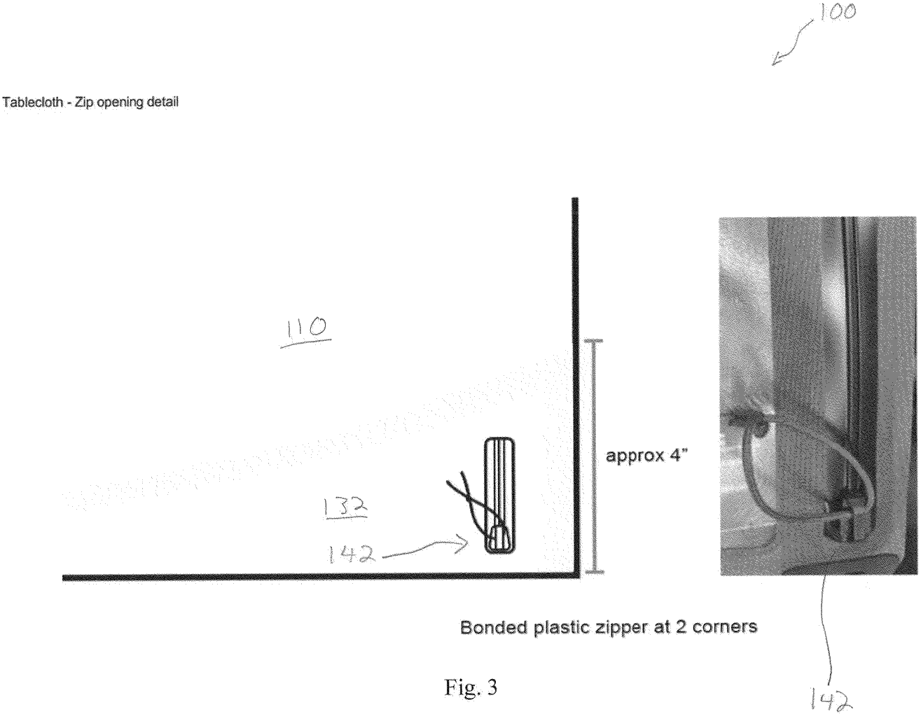

FIG. 3 illustrates a close-up of the zipper 142, as a line drawing on the left and a photograph on the right.

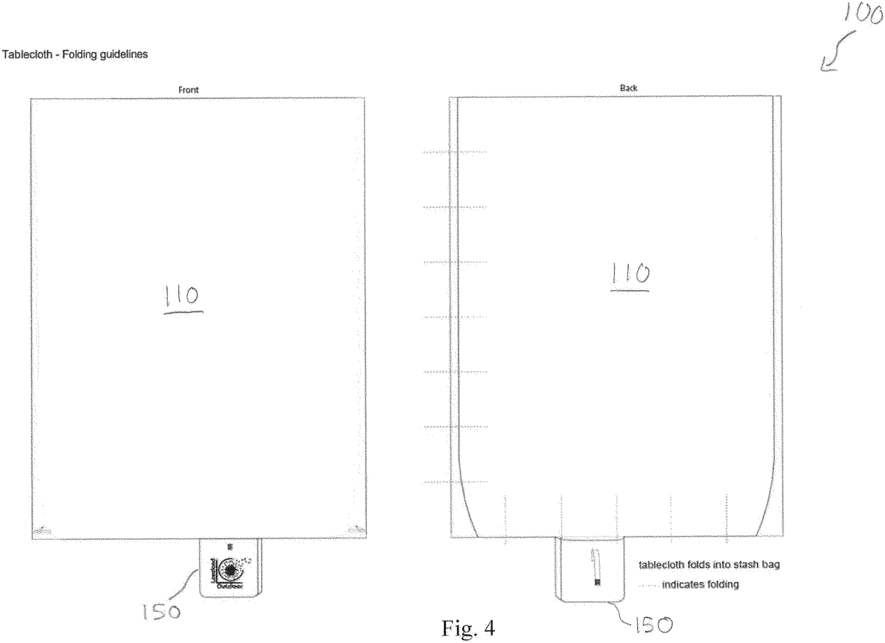

FIG. 4 illustrates the front (left side) and back (right side) of the covering 100, with folding lines depicted on the back view.

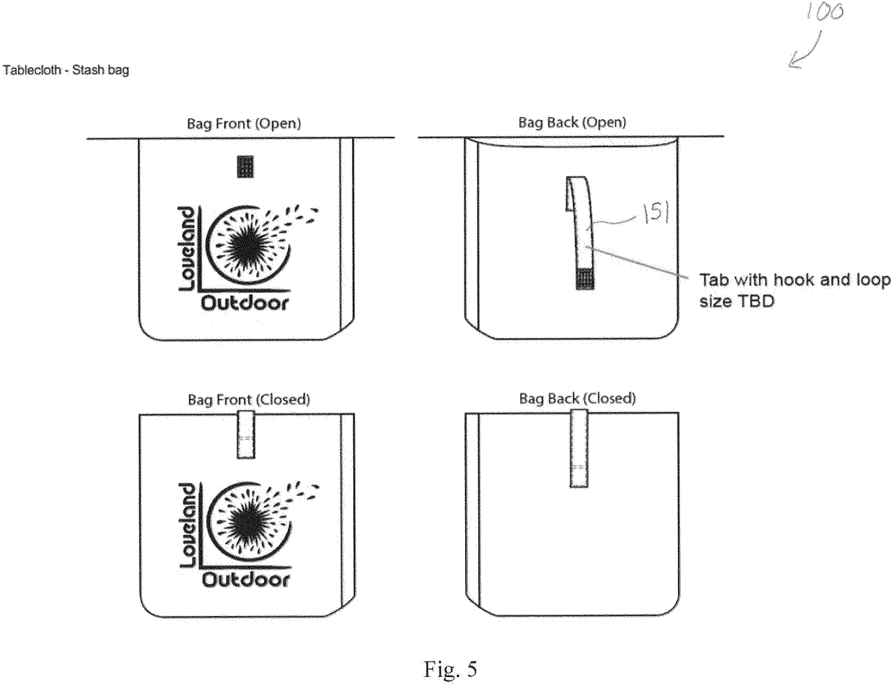

FIG. 5 illustrates operation of the tab 151 for securing the stashbag 150. In the upper left is a depiction of the stashbag 150 with the tab 151 unsecured. In the upper right is a depiction of the stashbag 150 with the tab 151 unsecured. In the lower left is a depiction of the stashbag 150 with the tab 151 secured. In the lower right is a depiction of the stashbag 150 with the tab 151 secured.

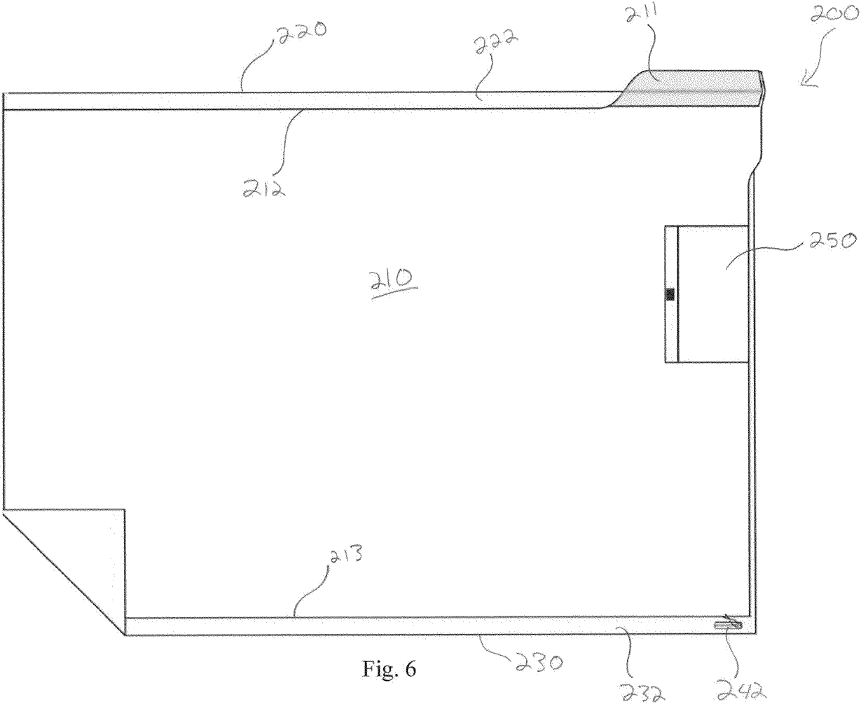

FIG. 6 depicts another embodiment of a covering, the covering 200 configured to be used as a tablecloth or picnic blanket. Covering 200 includes a first fabric layer 210. The covering 200 has four edges and includes a first new edge 220 with a fluid filled first void 222 and a second new edge 230 with a fluid filled second void 232. Covering 200 is similar to covering 100; however, covering 200 includes a second fabric layer 211 (a vinyl layer) in both the first void 222 (shown in yellow) and in the second void 232 (not shown, but present). The second fabric layer 211 increases the watertightness of the first and second voids 222 and 232. The covering 200 does not include a bladder in either of the first and second voids 222 and 232.

FIG. 6 illustrates a back of the covering 200. Fillable and drainable voids 222 and 232 are formed by folding, respectively, first edge 212 and second edge 213 each over on itself and then bonding the second fabric layer 211 to itself. Each of voids 222 and 232 is formed by bonding the second fabric layer 211, via a process such as via RF welding, along three edges of the respective void.

The covering 200 includes a first zipper (not shown) incorporated into the first fabric layer 210 and the second fabric layer 211 within the compartment of the first void 222. Additionally, the covering 200 includes a second zipper 242 incorporated into the first fabric layer 210 and the second fabric layer 211 (not shown) within the compartment of the second void 232.

The covering 200 further includes a stash bag 250, into which the remainder of the covering 200 may be folded and stored, when not in use. Water is preferably drained from the first and second voids 222 and 232 before folding the covering 200 into the stash bag 250.

The phrase “operably connected to” refers to any form of interaction between two or more entities, including mechanical, electrical, magnetic, electromagnetic, fluid, and thermal interaction. Two entities may interact with each other even though they are not in direct contact with each other. For example, two entities may interact with each other through an intermediate entity. Likewise, the phrase “fluidic communication” refers to direct and indirect fluidic communication between two entities.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A covering comprising a first fabric layer having a first edge folded over on itself to define a first new edge and forming a first void that can be filled with a fluid.

2. The covering of claim 1, wherein the covering is designed to be used outdoors.

3. The covering of claim 1, wherein the covering is shaped and configured to function as a tablecloth, a grill cover, a furniture cover, a napkin holder cover, a food container cover, a car cover, or a boat cover.

4. The covering of claim 1, further comprising a fluid in the void and wherein a weight of the fluid renders the covering resistant to wind up to 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, and more mph.

5. The covering of claim 4, wherein the fluid comprises water.

6. The covering of claim 1, wherein the covering includes 2, 3, 4, 5, 6, 7, 8, 9, 10, or more edges.

7. The covering of claim 1, wherein the covering includes a second void that can be filled with a fluid.

8. The covering of claim 7, wherein the second void is proximal a second new edge of the covering, wherein a second edge folded over on itself defines the second new edge and forms the second void.

9. The covering of claim 7, wherein the second void is proximal the first new edge and oriented in line with the first void when the covering is in use.

10. The covering of claim 1, wherein the first void is proximal the first new edge.

11. The covering of claim 1, wherein the first void is 1, 2, 3, 4, 5, 6, 7, 8, 9, 10, 11, 12, 13 14, 15, or more inches from the first new edge.

12. The covering of claim 1, further comprising a first orifice in fluidic communication with the first void, wherein fluid can be added or removed from the first void via the first orifice.

13. The covering of claim 1, further comprising a first cap operably connected to the first orifice and configured to removably seal off the first orifice.

14. The covering of claim 1, further comprising a first zipper operably connected to the first orifice and configured to slidably seal off the first orifice.

15. The covering of claim 1, wherein the first fabric layer comprises a woven or non-woven material comprised of natural or synthetic materials.

16. The covering of claim 1, wherein the first fabric layer further includes rigid plastic components, metal components, wood components, or any combination thereof.

17. The covering of claim 1, wherein the covering is flexible through at least ½ of the surface area of the covering.

18. The covering of claim 1, wherein the first fabric layer is bonded to itself via RF welding to form the first void.

19. The covering of claim 1, further comprising a second fabric layer on one-side of the first fabric layer and wherein the second fabric layer is bonded to itself via RF welding to form the first void.

20. The covering of claim 1, wherein the first void forms a water-tight compartment, without the need for a separate bladder.
